(19) United States
(12) Patent Application Publication
(10) Pub. No.: US 2013/0299211 A1
(43) Pub. Date: Nov. 14, 2013

(54) LIGHT WEIGHT BRAID FOR CABLE SHIELDING APPLICATIONS

(71) Applicant: General Cable Technologies Corporation, (US)

(72) Inventor: Bradley G. POPE, Waxhaw, NC (US)

(21) Appl. No.: 13/890,768

(22) Filed: May 9, 2013

Related U.S. Application Data
(60) Provisional application No. 61/645,945, filed on May 11, 2012.

(51) Int. Cl. H01B 7/18

(52) U.S. Cl. CPC H01B 7/1865
USPC 174/113 R

(57) ABSTRACT

A cable that includes at least one conductor, an insulation layer that surrounds the conductor, and a braid wrapped that is around the insulation layer. The braid is substantially formed of woven fiber. The woven fiber may include a metal coating.

### RELATED APPLICATION

This application claims priority under 35 U.S.C. §119(e) to U.S. Provisional Application Ser. No. 61/645,945, filed May 11, 2012, the subject matter of which is herein incorporated by reference in its entirety.

### FIELD OF THE INVENTION

The present invention relates to cable, such as coaxial data cable, that is light weight. More specifically, the present invention relates to cable that includes an improved braid and materials to significantly reduce the weight of the cable.

### BACKGROUND OF THE INVENTION

Conventional coaxial cable includes multiple components, such as a copper conductor, an insulation layer, aluminum foil wrapped around the insulation layer, a copper braid around the foil for providing shielding and strength to the cable, and an outer protective jacket. Such conventional cabling is often heavy because each of the multiple components above contributes to the weight of the cable, particularly the copper components. Because the cable is typically transported by trucks, the heavy weight of the cable significantly increases the expense of the transportation.

Therefore, a need exists for cable that is light in weight while maintaining optimal electrical and shielding properties. That need applies not only to trucks transporting the cable but also to other applications, such as avionics, large multi-floor buildings and portable broadcast vehicles.

### SUMMARY OF THE INVENTION

Accordingly, the present invention provides a cable that comprises at least one center conductor; an insulation layer that surrounds the at least one conductor; and a braid that is wrapped around the insulation layer. The braid may be formed of woven fiber with or without a metal coating or a combination of woven fiber and metal braid materials. In one preferred embodiment, the cable is a coaxial cable.

The present invention also provides a cable that comprises at least one center conductor that may be formed of aluminum with copper cladding. The cable also comprises an insulation layer that surrounds the at least one conductor; a braid that is wrapped around the insulation layer that may be formed of woven fiber; and an outer jacket that surrounds the braid.

Other objects, advantages and salient features of the invention will become apparent from the following detailed description, which, taken in conjunction with the annexed drawing, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing figures:

FIG. 1 is a perspective view of a coaxial cable according to an exemplary embodiment of the invention, showing each component of the cable; and

FIG. 2 is a perspective view of a shielded data cable according to an exemplary embodiment of the invention, showing each component of the cable.

### DETAILED DESCRIPTION OF THE INVENTION

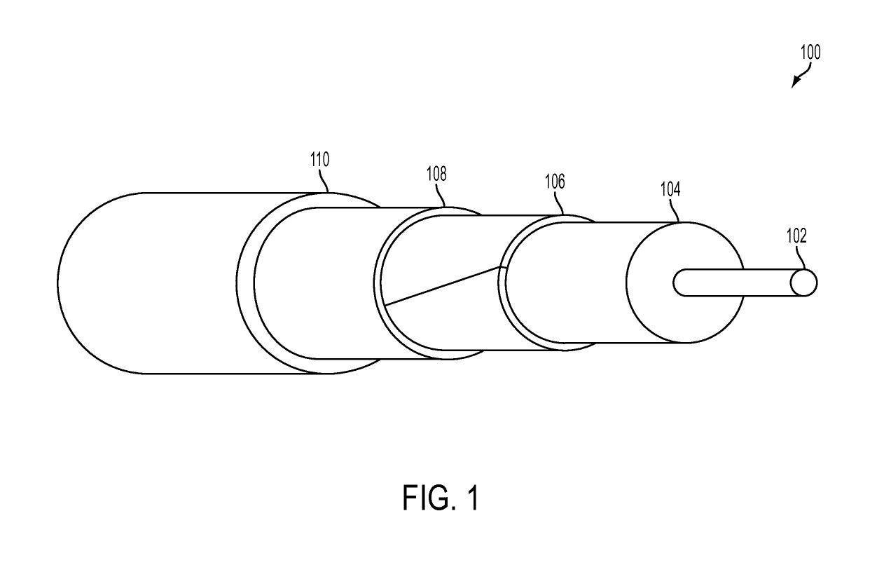

Referring to FIG. 1, the present invention relates to a light weight cable 100. The light weight cable 100 may be a coaxial cable, for example, that generally includes a conductor or conductors 102, an insulation layer 104 surrounding the conductor 102, a braid 108 wrapped around the insulation layer 104, and an outer protective jacket 110. An optional shield 106 may be provided around the insulation layer 104 of the cable.

The braid 108 is preferably made of fiber, with or without a metal coating, or a combination of fiber and metal braid material. The fiber strands are woven together to form the braid or the combination of fiber and metal braid material are woven together to from the braid. Unlike the copper braids of the prior art, braid 108 is lighter in weight and stronger than conventional copper braids. This braid may or may not provide conductivity for shielding. More specifically, the fiber of the braid has higher strength properties than copper and is also significantly lighter in weight than copper. When metal-coated fiber is used, the metal coating of the braid 108 provides sufficient conductivity for shielding without adding any weight. The fiber of the braid 108 may be formed of polyester, nylon, cotton, fiberglass, aramid, polyimide and the like. When metal coated fiber is used, the metal coating may be any metal, such as nickel, copper, tin or silver.

The conductor 102 are preferably formed of aluminum with a copper cladding; however, solid copper conductors could be used in combination with the light weight fiber. This also reduces the weight of the cable 100 because aluminum is significantly lighter in weight than copper. Because the conductor 102 includes a copper cladding, optimum electrical properties are maintained.

The insulation layer 104 may be formed of any conventional insulation material, such as polyethylene or fluorinated ethylene propylene, that is either foamed or solid. Similarly, the outer jacket 110 may be formed of any conventional jacket material, such as PVC. The optional shield 106 may be an aluminum foil layer.

In addition to the features of the cable 100 described above, the cable 100 may also include an optional dielectric insulator surrounding the inner conductor 102. The shield 106 may be divided into an inner shield and an outer shield, where an interlayer or interlayer shield is located between the inner shield and outer shield. The dielectric insulator may be formed of solid polytetrafluoroethylene (PTFE) or other suitable material.

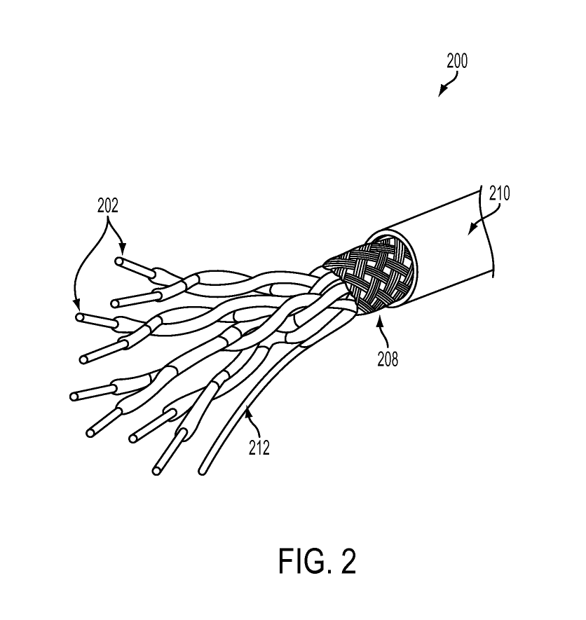

Referring to FIG. 2, a second exemplary embodiment of the cable is preferably a data cable 200. The data cable 200 generally includes one or more insulated conductors twisted into pairs 202, as is known in the art, a braid 208 wrapped around the insulated conductor pairs 202, and an outer protective jacket 210. An optional drain or grounding wire 212 may be included with the core of conductor pairs 202.

Like the braid 108 of the first embodiment, the braid 208 is preferably made of fiber, with or without a metal coating, or a combination of fiber and metal braid material. The fiber strands are woven together to form the braid 208 or the combination of fiber and metal braid material are woven together to from the braid 208.

While particular embodiments have been chosen to illustrate the invention, it will be understood by those skilled in the art that various changes and modifications can be made therein without departing from the scope of the invention as defined in the appended claims. For example, the same weight reduction concepts of the present invention can be applied to power cable.

What is claimed is:

1. A cable, comprising:
at least one conductor;
an insulation layer surrounding said at least one conductor; and
a braid wrapped around said insulation layer, said braid being substantially formed of woven fiber.

2. A cable according to claim 1, wherein
said woven fiber of said braid includes a metal coating.

3. A cable according to claim 2, wherein
said metal coating is one of nickel, copper, tin or silver.

4. A cable according to claim 1, wherein
said woven fiber of said braid is one of polyester, nylon, cotton, fiberglass, aramid, and polyimide.

5. A cable according to claim 1, wherein
said braid includes metal strands.

6. A cable according to claim 1, wherein
said at least one conductor is formed of aluminum with copper cladding.

7. A cable according to claim 1, wherein
said insulation layer is formed of polyethylene or fluorinated ethylene propylene

8. A cable according to claim 1, further comprising
an outer jacket surrounding said braid.

9. A cable according to claim 1, further comprising
a shield surrounding said insulation layer.

10. A cable according to claim 1, wherein
the cable is one of a coaxial cable or a data cable.

11. A cable, comprising:
at least one center conductor, said at least one center conductor being formed of aluminum with copper cladding;
an insulation layer surrounding said at least one center conductor;
a braid wrapped around said insulation layer, said braid being substantially formed of woven fiber; and
an outer jacket surrounding said braid.

12. A cable according to claim 11, wherein
said woven fiber of said braid is one of polyester, nylon, cotton, fiberglass, aramid, and polyimide.

13. A cable according to claim 11, wherein
said woven fiber includes a metal coating.

14. A cable according to claim 13, wherein
said metal coating is one of nickel, copper, tin or silver.

15. A cable according to claim 11, wherein
said braid includes metal strands.

16. A cable according to claim 11, wherein
said insulation layer is formed of polyethylene or fluorinated ethylene propylene.

17. A cable according to claim 16, wherein
said outer jacket is formed of PVC.

18. A cable according to claim 17, further comprising
a shield surrounding said insulation layer.

19. A cable according to claim 18, wherein
the cable is one of a coaxial cable or data cable.

20. A cable, comprising:
a plurality of twisted pairs of insulated conductors;
a braid wrapped around said plurality of twisted pairs of insulated conductors, said braid being substantially formed of woven fiber; and
an outer jacket surrounding said braid.

21. A cable according to claim 20, wherein
said woven fiber of said braid is one of polyester, nylon, cotton, fiberglass, aramid, and polyimide.

22. A cable according to claim 20, wherein
said woven fiber includes a metal coating.

23. A cable according to claim 22, wherein
said metal coating is one of nickel, copper, tin or silver.

24. A cable according to claim 20, wherein
said braid includes metal strands.
